(19) United States
(12) Patent Application Publication
(10) Pub. No.: US 2015/0045468 A1
(43) Pub. Date: Feb. 12, 2015

(54) METHOD FOR MANUFACTURING FOAM-MOLDED ARTICLE, AND FOAM-MOLDED ARTICLE

(71) Applicant: KYORAKU CO., LTD., Kyoto (JP)

(72) Inventor: Masaaki Onodera, Yamato-shi (JP)

(73) Assignee: KYORAKU CO., LTD., Kyoto (JP)

(21) Appl. No.: 14/375,654

(22) PCT Filed: Jan. 22, 2013
(86) PCT No.: PCT/JP2013/051124

§ 371 Date: Jul. 30, 2014

(30) Foreign Application Priority Data
Jan. 30, 2012 (JP) 2012-017033

(51) Int. Cl. C08J 9/30; B29C 44/02

(52) U.S. Cl. CPC C08J 9/30; B29C 44/02; B29K 2023/0633
USPC 521/134; 264/41

(57) ABSTRACT

A foam-molded article has high weldability to a polypropylene-based resin molded article, a high expansion ratio, and a predetermined level of impact resistance despite using inexpensive polyethylene-based resin. The foam-molded article includes a foamed and molded base material resin in which a first polyethylene-based resin, a second polyethylene-based resin, and a polypropylene-based resin are mixed. The first polyethylene-based resin has a long-chain branched structure and a density of 0.920 g/cm³ or more. The second polyethylene-based resin is manufactured by a low pressure slurry method, and has a long-chain branched structure and a density of 0.920 g/cm³ or less. The second polyethylene-based resin has a melt tensile force of 70 mN or more at 160° C. The polypropylene-based resin has a compounding ratio of 20% or more by weight of the base material resin.

### TECHNICAL FIELD

The present invention relates to a method for manufacturing a foam-molded article used in a climate control duct for vehicles, for example, and to a foam-molded article.

### BACKGROUND ART

Conventionally, for example, in a case of a component or the like to be mounted in a vehicle instrument panel, a foam-molded article may be integrated with another member such as the instrument panel.

There is a known method for integrating the foam-molded article with the other member. In this method, while pressing one member against the other member, a contacting portion therebetween is caused to generate heat by ultrasonic vibration from an ultrasonic welder. The heat melts and welds areas around the contacting portions.

Generally, many polyethylene-based resins are less expensive than polypropylene-based resin. Thus, in many cases, a foam-molded article can be manufactured at lower cost using a polyethylene-based resin than by using only a polypropylene-based resin.

One of techniques using polyethylene-based resin is as follows (see, for example, Patent Literature 1), a resin used is obtained by mixing 60 to 30 wt % of high-density polyethylene as resin A with 40 to 70 wt % of low-density polyethylene as resin B. In this way, an attempt has been made to construct an automobile duct formed of inexpensive materials and including a small number of different mixed materials.

### CITATION LIST

### Patent Literature

Patent Literature 1: JP-A-2011-194700

### SUMMARY OF THE INVENTION

### Problems to be Solved by the Invention

In many cases, however, instrument panels and the like used in vehicles are polypropylene-based resin molded articles. Thus, a foam-molded article may be welded to a polypropylene-based resin molded article to integrate them with each other. In this case, it has been difficult to weld the foam-molded article including only the inexpensive polyethylene-based resin because of differences in physical properties between the polypropylene-based resin and the polyethylene-based resin.

Further, even when it is attempted to simply mix polypropylene-based resin with polyethylene-based resin, it has been difficult to increase their expansion ratio unless the respective resins are cleanly mixed.

When applied as an on-board component, for example, it is desirable, for practical reasons, that the foam-molded article has at least such a level of impact resistance that cracks are not readily caused during use.

The technique of Patent Literature 1 described above does not consider the welding and integration of such polypropylene-based resin molded articles.

The present invention was made in view of such circumstances. An object of the present invention is to provide a method for manufacturing a foam-molded article using a polyethylene-based resin and having excellent weldability to a polypropylene-based resin molded article, a high expansion ratio, and a predetermined level of impact resistance, and to provide a foam-molded article.

### Solutions to the Problems

To solve these problems, a method for manufacturing a foam-molded article according to the present invention includes foaming and molding a base material resin in which a first polyethylene-based resin, a second polyethylene-based resin, and a polypropylene-based resin are mixed. The first polyethylene-based resin has a long-chain branched structure with a density of 0.920 g/cm³ or more; the second polyethylene-based resin is manufactured by a low pressure slurry method, has a long-chain branched structure with a density of 0.920 g/cm³ or less, and has a melt tensile force of 70 mN or more at 160° C.; and the polypropylene-based resin has a compounding ratio of 20% or more by weight of the base material resin.

In addition, a foam-molded article according to the present invention is obtained by foaming and molding a base material resin in which a first polyethylene-based resin, a second polyethylene-based resin, and a polypropylene-based resin are mixed. The first polyethylene-based resin has a long-chain branched structure with a density of 0.920 g/cm³ or more; the second polyethylene-based resin is manufactured by a low pressure slurry method, has a long-chain branched structure with a density of 0.920 g/cm³ or less, and has a melt tensile force of 70 mN or more at 160° C.; and the polypropylene-based resin has a compounding ratio of 20% or more by weight of the base material resin.

### Effects of the Invention

Thus, the present invention provides a low-cost foam-molded article using polyethylene-based resin, the foam-molded article having excellent weldability to a polypropylene-based resin molded article, a high expansion ratio, and a predetermined level of impact resistance.

### BRIEF DESCRIPTION OF THE DRAWINGS

FIG. 1 is a perspective view of an example of a duct 10 as an embodiment of the present invention.

FIG. 2 is a cross-sectional diagram illustrating an embodiment of blow molding of the duct 10 illustrated in FIG. 1.

### DESCRIPTION OF EMBODIMENTS

In the following, an embodiment of a method for manufacturing a foam-molded article and an embodiment of a foam-molded article of the present invention, which are applied to a vehicular climate control duct will be described with reference to the drawings.

The present invention is not limited to vehicular climate control ducts and may be applied to any of other foam-molded articles. Examples of these other foam-molded articles include automobile interior components, such as door panels, instrument panels, and vehicular deck boards; housing interior wall materials; electronic device housings; and gas or liquid supply ducts for purposes other than vehicles.

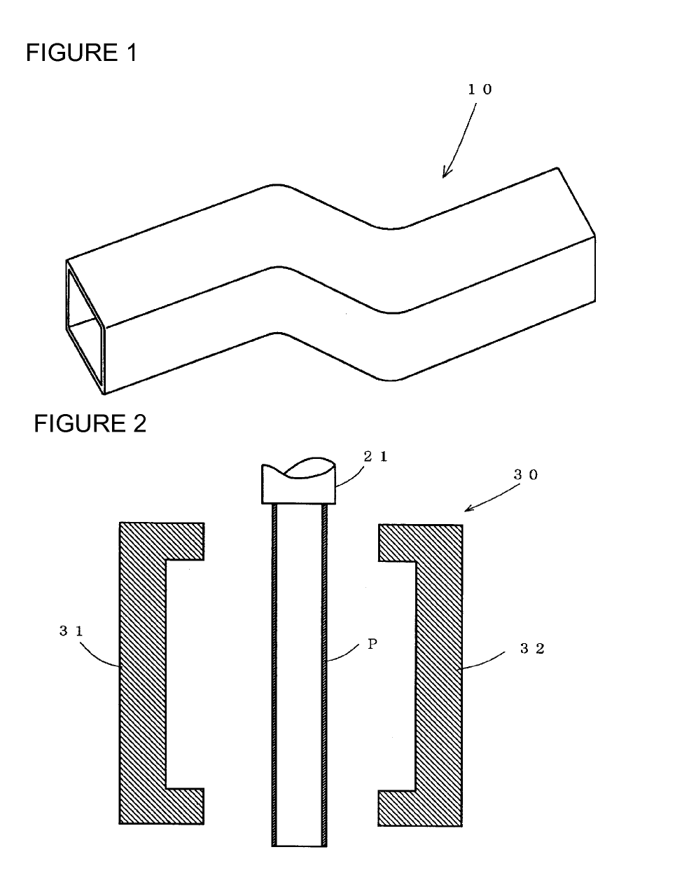

FIG. 1 illustrates a duct 10 of an embodiment of the present invention which is configured to circulate climate control air supplied from an air conditioning unit (not shown) through a channel in the duct so as to ventilate a desired location. The duct is mounted in a vehicle by being welded to and integrated with a molded article of polypropylene-based resin, such as an instrument panel of the vehicle.

The duct 10 of the present embodiment may have any shape not limited to one illustrated in FIG. 1. In other words, the duct 10 may have any desired shape adapted to the intended use of the duct 10, its installed location, or the like.

The duct 10 of the present embodiment is obtained by blow molding a foamed parison sandwiched between molds. The foamed parison is formed by extruding a foamable resin from an annular die of an extruder. The ends of the duct immediately after blow molding are closed. Trimming after blow molding makes the ends of the duct cut out to give opened ends of the duct. The blow molding will be described later.

In the duct 10 of the present embodiment, foamed cells have preferably an average cell diameter of less than 300 μm in the direction along the pipe wall thickness of the duct 10 of the present embodiment. In this case, an advantage of increased mechanical strength can be obtained. More preferably, the average cell diameter is less than 100 μm.

The duct 10 has a closed cell structure with an expansion ratio of 1.5 times or more. The term “expansion ratio” used herein refers to a value obtained by dividing the density of the thermoplastic resin used for foamed blow molding by the apparent density of the pipe wall of the foamed blow molding article. The term “closed cell structure” used herein refers to a structure having a plurality of foamed cells with a closed cell ratio of at least 70% or more.

The closed cell structure, because of its expansion ratio of 1.5 times or more, enables a further decrease in weight compared with other cases, and also enables a further increase in thermal insulating property. Thus, even when cooling air is circulated in the duct, the likelihood of dew condensation can be almost eliminated.

Furthermore, the duct 10 of the present embodiment may preferably have both an impact resistance and a stiffness enough to prevent itself from producing cracks and shattering during transport or assembly of the duct 10 and even at the time of expanding an airbag of the vehicle.

Thus, the impact resistance is preferably one that allows a 1-kg ball at a height of 30 cm or more to generate cracks when the ball is dropped on the duct 10 at minus 10° C. As long as in this range, compared with a case out of the range, the obtainable level of the impact resistance can be the extent to which cracks are hardly caused during use of the duct 10 in a vehicle or the like.

More preferably, furthermore, the above height at which clacks can be generated is 40 cm or more. As long as in this range, compared with a case out of the range, a sufficient impact resistance can be obtained substantially without any crack even during transport, assembly, or use of the duct.

With respect to the stiffness, preferably, the pipe wall of the duct 10 has a tensile elastic modulus of 1,500 kg/cm² or more. As long as in this range, compared with a case out of the range, the duct can be effectively prevented from deforming during transport, assembly, or use of the duct.

The tensile elastic modulus is a value measured at normal temperature (23° C.) according to JIS K-7113, using a Type-2 test specimen at normal temperature (23° C.) at a tensile rate of 50 mm/min.

As described above, the duct 10 of the present embodiment is mounted in a vehicle by being welded to and integrated with a polypropylene-based resin molded article, for example, such as a vehicle instrument panel. During the welding, the duct 10 of the present embodiment is pressed against the polypropylene-based resin molded article as the welding target. Under such conditions, only areas around their contacting portions are heated and melted by vibrating the duct 10 with an ultrasonic welder to weld the contacting portions. The duct 10 of the present embodiment is therefore required to have excellent weldability to the polypropylene-based resin molded article.

Hence, the duct 10 of the present embodiment is obtained by adding a foaming agent to a base material resin obtained by mixing a polypropylene-based resin, a foaming polyethylene-based resin, and a low-density polyethylene-based resin, and then performing foamed blow molding on the base material resin.

Preferably, the polypropylene-based resin used is polypropylene having a melt tension in the range of 30 to 350 mN at 230° C. The term “melt tension” used herein refers to melt tensile force. A high expansion ratio can be obtained when the melt tension is in the above range because the foaming polypropylene-based resin exhibits strain hardening.

Preferably, the foaming polyethylene-based resin and the low-density polyethylene-based resin have a long-chain branched structure. Preferably, the long-chain branched structure has 0.01 or more and 3 or less long-chain branches per 1,000 carbon atoms as the number of branches of a hexyl group (carbon number 6) or more as detected by ¹³C-NMR measurement, and has a weight average molecular weight (Mw) of 100,000 or more and 1,000,000 or less.

If the number of branches is less than 0.01, a foamed layer cannot be formed. Meanwhile, if the number of branches is more than 3, heat resistance and stiffness deteriorate. If the weight average molecular weight is less than 100,000, resulting in difficulty in shape retention; if greater than 1,000,000, molding becomes difficult.

Preferably, the high-density foaming polyethylene-based resin has a density of 0.920 g/cm³ or more at normal temperature (23° C.), and a melt tension (MT) of 100 to 250 mN. Preferably, the resin has a melt flow rate (MFR) of 3 to 7 g/10 min. If the MT and MFR are outside these ranges, a good foamed layer cannot be obtained compared with those within these ranges.

The MT is a tensile force as described below. A strand is extruded out of an orifice with a diameter of 2.095 mm and a length of 8 mm, at a residual heat temperature of 160° C. and an extrusion rate of 5.7 mm/min. The MT indicates the tensile force measured using a melt tension tester (manufactured by Toyo Seiki Seisaku-Sho, Ltd.) when the strand was wound on a roller with a diameter of 50 mm at a winding speed of 100 rpm.

The MFR is a value measured according to JIS K-6922-1 at a test temperature of 190° C. and with a test load of 2.16 kg.

It is also preferred that the high-density foaming polyethylene-based resin have a flexural modulus (JIS K6922) of 700 MPa or more. In this range, stiffness can be further improved compared with the case outside the range.

The flexural modulus is a value measured according to JIS K6922-2.

Preferably, the low-density polyethylene-based resin is manufactured by low pressure slurry method, and has a density of 0.920 g/cm³ or less at normal temperature (23° C.) and a melt tension (MT) of 70 mN or more at the residual heat temperature of 160° C. In this range, compared with the case outside the range, the polypropylene-based resin and the foaming polyethylene-based resin can be mixed better. As a result, the expansion ratio can be more readily increased. Further, the impact resistance at low temperature can be increased.

Preferably, the melt tension (MT) and the MFR are such that MT×MFR is 300 (mN·g/10 min) or more. In this range, compared with the case outside the range, pinholes are not readily caused when a shape corresponding to the mold surface irregularities is formed, thus improving moldability.

Of the compounding ratios by weight of the polypropylene-based resin, the foaming polyethylene-based resin, and the low-density polyethylene-based resin in the base material resin, the compounding ratio by weight of the polypropylene-based resin is 20 to 70 wt % with respect to the total amount of the base material resin.

When the compounding ratio is in this range, sufficient weldability of the polypropylene-based resin with respect to the molded article can be ensured even when the composition uses the inexpensive polyethylene-based resin. In addition, the expansion ratio can also be sufficiently increased. Thus, impact resistance of a level such that cracks are not readily caused even during use in a vehicle and the like can be ensured.

Preferably, the low-density polyethylene-based resin in the base material resin has a compounding ratio by weight of 10 to 20 wt % with respect to the total amount of the base material resin.

When the compounding ratio is in this range, sufficient impact resistance such that cracks are not readily caused and sufficient stiffness without deformation can be ensured even during transport, assembly, or use of the duct 10.

Preferably, the compounding ratio by weight of the foaming polyethylene-based resin in the base material resin with respect to the total amount of the base material resin is 50 wt % or more. When the compounding ratio is in this range, the expansion ratio can be further increased.

The base material resin is foamed using a foaming agent prior to blow molding.

Examples of the foaming agent include inorganic foaming agents, such as air, carbonic acid gas, nitrogen gas, or water, and organic foaming agents, such as butane, pentane, hexane, dichloromethane, or dichloroethane.

Preferably, among others, air, carbonic acid gas, or nitrogen gas is used as a foaming agent. In this case, entry of tangible matter can be prevented. Thus, a decrease in durability or the like can be suppressed.

Preferably, a foaming method involving the use of supercritical fluid is used. Specifically, it is preferred that the mixture resin be foamed by placing carbonic acid gas or nitrogen gas in supercritical state. In this case, uniform and reliable cells can be obtained.

The conditions in the case where the supercritical fluid is nitrogen gas may include a critical temperature of −149.1° C. and a critical pressure of 3.4 MPa or more. The conditions in the case where the supercritical fluid is carbonic acid gas may include a critical temperature of 31° C. and a critical pressure of 7.4 MPa or more.

The base material resin after the foaming process is blow molded by a well-known method to mold the duct 10 of the present embodiment.

FIG. 2 is a cross-sectional view illustrating the blow molding of the duct 10 of the present embodiment.

First, in the extruder, the polypropylene-based resin, the foaming polyethylene-based resin, and the low-density polyethylene-based resin are kneaded at predetermined ratios to prepare the base material resin.

At this time, the compounding ratio of each of them in the base material resin is provided as a weight ratio with respect to the total amount of the base material resin as described below. That is, the polypropylene-based resin has a compounding ratio of 20 to 70 wt %. Preferably, the low-density polyethylene-based resin has a compounding ratio of 10 to 20 wt %. More preferably, the foaming polyethylene-based resin has a compounding ratio of 50 wt % or more.

The resultant base material resin is mixed with the added foaming agent in the extruder, and then accumulated in an in-die accumulator (not shown). After a predetermined amount of resin is accumulated, a ring-shaped piston (not shown) is pressed down vertically with respect to the horizontal direction.

Then, a cylindrical parison P is extruded from a die slit of an annular die 21 between split mold blocks 31 and 32 constituting a clamping machine 30, as illustrated in FIG. 2, at an extrusion rate of 700 kg/h or more.

Thereafter, the split mold blocks 31 and 32 are clamped, thus sandwiching the parison P. Subsequently, air is blown into the parison P at a pressure ranging from 0.05 to 0.15 MPa to form the duct 10.

The method of molding of the foam-molded article is not limited to the blow molding as described above, and may include vacuum molding where a predetermined shape of molded article is molded by suctioning the extruded parison onto the mold. Alternatively, the foam-molded article may be molded by compression molding where the extruded parison is sandwiched between the molds for molding without blowing or suctioning air.

As described above, the duct 10 of the present embodiment is manufactured by adding a foaming agent to the base material resin in which the polypropylene-based resin, the foaming polyethylene-based resin, and the low-density polyethylene-based resin are mixed, and then performing foamed blow molding.

Of the compounding ratios by weight of the polypropylene-based resin, the foaming polyethylene-based resin, and the low-density polyethylene-based resin in the base material resin, the compounding ratio by weight of the polypropylene-based resin with respect to the total amount of the base material resin is 20 to 70 wt %.

Thus, despite the fact that the foam-molded article uses the inexpensive polyethylene-based resin in addition to the polypropylene-based resin, sufficient weldability to the molded article of the polypropylene-based resin can be ensured. Further, the expansion ratio can be increased by a factor of 1.5 or more. Accordingly, a duct having sufficient lightness and thermal insulating property even for vehicular purposes, for example, can be obtained. In addition, impact resistance of a level such that cracks are not readily caused even during use on vehicles and the like can be ensured.

Preferably, the low-density polyethylene-based resin in the base material resin has a compounding ratio by weight of 10 to 20 wt % with respect to the total amount of the base material resin.

The compounding ratio makes it possible to obtain a duct having sufficient impact resistance such that cracks are not readily caused during transport, assembly, or use of the duct even when applied in a so-called instrument panel duct, for example, that is used by being welded to the vehicle instrument panel. In addition, a duct having sufficient stiffness such that no deformation is caused even during transport, assembly, or use of the duct can be obtained.

Preferably, the foaming polyethylene-based resin in the base material resin has a compounding ratio by weight of 50 wt % or more with respect to the total amount of the base material resin. The compound ratio can result in a duct having a further increase in expansion ratio. Thus, a duct having better lightness and thermal insulating property can be obtained.

### EXAMPLES

In the following, the present invention will be described more specifically with reference to the examples and the comparative examples. However, the present invention is not limited to the following examples.

First, the polypropylene-based resin, the foaming polyethylene-based resin, and the low-density polyethylene-based resin used in the examples and comparative examples are as follows.

### <Polypropylene-Based Resin>

PP1: Block polypropylene (manufactured by Japan Polypropylene Corporation; trade name “NOVATEC BC8”)
PP2: Propylene homopolymer (manufactured by Borealis AG; trade name “Daploy WB 140”)

### <Foaming Polyethylene-Based Resin>

PE1: Linear long-chain branched high melt strength polyethylene manufactured by low pressure slurry method (manufactured by Tosoh Corporation; trade name “TOSOH-HMS”, Item Number “08S55A”)

### <Low-Density Polyethylene-Based Resin>

PE2: Linear long-chain branched high melt strength polyethylene manufactured by low pressure slurry method (manufactured by Tosoh Corporation; trade name “TOSOH-HMS JK17”)
PE3: Network long-chain branched low-density polyethylene manufactured by high pressure radical method (manufactured by Sumitomo Chemical Co., Ltd., trade name “Sumikasen F108-1”)
PE4: Linear short-chain branched polyethylene (manufactured by Sumitomo Chemical Industries Co., Ltd.; trade name “Excellen FX201”)

Table 1 shows the MT (melt tension) (mN), MFR (melt flow rate) (g/10 min), MT×MFR (mN·g/10 min), density (g/cm³), tensile elastic modulus (MPa), and flexural modulus (MPa) of these resins.

The MT of the polypropylene-based resin is a tensile force measured using the melt tension tester (manufactured by Toyo Seiki Seisaku-Sho, Ltd.) as follows. A strand was extruded from an orifice with a diameter of 2.095 mm and a length of 8 mm at a residual heat temperature of 230° C. and an extrusion rate of 5.7 mm/min. The MT indicates the tensile force measured when the strand was wound on a roller with a diameter of 50 mm at a winding speed of 100 rpm. However, the MT of PP2 was measured at a winding speed of 0.8 m/min.

The MFR is a value measured according to JIS K-7210 at a test temperature of 230° C. and with a test load of 2.16 kg.

The density is a value measured at normal temperature (23° C.).

The tensile elastic modulus is a value measured at normal temperature (23° C.) according to JIS K-7113, using the type 2 test piece at normal temperature (23° C.) and at a tensile rate of 50 mm/min.

The MT of the polyethylene-based resin is a tensile force measured using the melt tension tester (manufactured by Toyo Seiki Seisaku-Sho, Ltd.) as follows. A strand was extruded from the orifice with the diameter of 2.095 mm and the length of 8 mm, at a residual heat temperature of 160° C. and an extrusion rate of 5.7 mm/min. The MT indicates the tensile force measured when the strand was wound on the roller with the diameter of 50 mm at a winding speed of 100 rpm.

The MFR is a value measured according to JIS K-6922-1 at a test temperature of 190° C. and with a test load of 2.16 kg.

The density is a value measured at normal temperature (23° C.).

The tensile elastic modulus is a value measured at normal temperature (23° C.) according to JIS K-7113, using the type 2 test piece at a tensile rate of 50 mm/min.

The flexural modulus is a value measured according to JIS K6922-2.

TABLE 1

| | | | | | Tensile | |
|---|---|---|---|---|---|---|
| | | | MT × MFR | | Elastic | Flexural |
| | MT | MFR | (mN · g/ | Density | Modulus | Modulus |
| | (mN) | (g/10 min) | 10 min) | (g/cm³) | (MPa) | (MPa) |
| PP1 | 35.7 | 1.70 | 60.7 | 0.90 | 1181 | No Data |
| PP2 | 239.4 | 2.1 | 503 | 0.90 | 1772 | No Data |
| PE1 | 120 | 4 | 480 | 0.950 | 900 | 810 |
| PE2 | 77 | 4 | 308 | 0.915 | 270 | 240 |
| PE3 | 58 | 1.06 | 61.5 | 0.921 | 275 | No Data |
| PE4 | 8 | 2 | 16 | 0.898 | No Data | No Data |

### Example 1

The base material resin was obtained by mixing 70 wt % of PP1, 20 wt % of PE1, and 10 wt % of PE2.

The base material resin was foamed by adding nitrogen in supercritical state as the foaming agent, 1.0 part by weight of an LDPE-based master batch (manufactured by Dainichiseika Color & Chemicals Mfg. Co., Ltd.; trade name “Finecell Master P0217K”) as a nucleating agent containing 20 wt % of sodium hydrogen carbonate-based foaming agent, and 1.0 parts by weight of LLDPE-based master batch as a coloring agent containing 40 wt % of carbon black. In this way, a foamed resin was obtained. After kneading in an extruder, the resin was accumulated in the in-die accumulator, which is a cylindrical space between a mandrel and an outer die tube, and then extruded between the split mold blocks as a cylindrical parison, using a ring-shaped piston. After clamping, air was blown into the parison at a pressure of 0.1 MPa. In this way, a blow molded sample was obtained.

### Example 2

The base material resin was obtained by mixing 20 wt % of PP1, 70 wt % of PE1, and 10 wt % of PE2.

Subsequent steps were performed in the same way as in Example 1, resulting in a blow molded sample.

### Example 3

The base material resin was obtained by mixing 60 wt % of PP1, 20 wt % of PE1, and 20 wt % of PE2.

Subsequent steps were performed in the same way as in Example 1, resulting in a blow molded sample.

### Example 4

The base material resin was obtained by mixing 55 wt % of PP1, 30 wt % of PE1, and 15 wt % of PE2.

Subsequent steps were performed in the same way as in Example 1, resulting in a blow molded sample.

### Example 5

The base material resin was obtained by mixing 65 wt % of PP1, 30 wt % of PE1, and 5 wt % of PE2.

Subsequent steps were performed in the same way as in Example 1, resulting in a blow molded sample.

### Example 6

The base material resin was obtained by mixing 50 wt % of PP1, 20 wt % of PE1, and 30 wt % of PE2.

Subsequent steps were performed in the same way as in Example 1, resulting in a blow molded sample.

### Comparative Example 1

The base material resin was obtained by mixing 70 wt % of PP1, 20 wt % of PE1, and 10 wt % of PE3.

Subsequent steps were performed in the same way as in Example 1, resulting in a blow molded sample.

### Comparative Example 2

The base material resin was obtained by mixing 70 wt % of PP1, 20 wt % of PE1, and 10 wt % of PE4.

Subsequent steps were performed in the same way as in Example 1, resulting in a blow molded sample.

### Comparative Example 3

The base material resin was obtained by mixing 10 wt % of PP1, 70 wt % of PE1, and 20 wt % of PE2.

Subsequent steps were performed in the same way as in Example 1, resulting in a blow molded sample.

### Comparative Example 4

The base material resin was obtained by mixing 80 wt % of PE1 and 20 wt % of PE2.

Subsequent steps were performed in the same way as in Example 1, resulting in a blow molded sample.

### Comparative Example 5

The base material resin was obtained by mixing 70 wt % of PP1 and 30 wt % of PE1.

Subsequent steps were performed in the same way as in Example 1, resulting in a blow molded sample.

### Comparative Example 6

The base material resin was obtained by mixing 60 wt % of PP1, 20 wt % of PP2, and 20 wt % of PE2.

Subsequent steps were performed in the same way as in Example 1, resulting in a blow molded sample.

The physical property of the samples obtained according to Examples 1 to 6 and Comparative Examples 1 to 6 was evaluated as follows.

### <Weldability>

Using a 12 mm head of the ultrasonic welder SONOPET 335 manufactured by Seidensha Electronics Co., Ltd., the samples of the foam-molded article according to Examples 1 to 6 and Comparative Examples 1 to 6 were pressed against an instrument panel member of polypropylene-based resin under the conditions of the frequency of 39.5 Hz, normal temperature, and pressing strength of 85 N for 5 seconds, thus welding the samples. Thereafter, using the TENSILON universal material testing machine RTC-1325A manufactured by Orientec Co., Ltd., weld strength was measured under the condition of a tensile rate of 10 mm/min. Weld strength of 10 kgf or more was evaluated to be “Good”; the other cases were evaluated to be “Not Acceptable (NA)”.

### <Expansion Ratio>

The expansion ratio was calculated by dividing the density of the mixture resin used in Examples 1 to 6 and Comparative Examples 1 to 6 by the apparent density of a wall portion of the corresponding foam-molded article sample.

### <Foamability>

When the expansion ratio calculated as described above was 1.5 times or more, the foamability was evaluated to be “Good”; the other cases were evaluated to be “Not Acceptable (NA)”.

### <Impact Resistance>

Impact resistance was measured by dropping a sphere of 1 kg onto the foam-molded article samples according to Examples 1 to 6 and Comparative Examples 1 to 6 at minus 10° C. In this case, when the height at which cracks appeared was 40 cm or more, the impact resistance was evaluated to be “Good”. When the height was less than 40 cm and 30 cm or more, the impact resistance was evaluated to be “Acceptable”; the other cases were evaluated to be “Not Acceptable (NA)”.

### <Stiffness>

The tensile elastic modulus was measured according to JIS K-7113 using the type 2 test piece at normal temperature (23° C.) and a tensile rate of 50 mm/min. When the obtained value was 1,500 kg/cm² or more, the stiffness was evaluated to be “Good”; the other cases were evaluated to be “Not Acceptable (NA)”.

Table 2 shows, with respect to Examples 1 to 6 and Comparative Examples 1 to 6, the compounding ratios in the base material resin of PP1, PP2, and PE1 to PE4, and the weldability, foamability, expansion ratio, impact resistance, and stiffness evaluated as described above.

TABLE 2

| | Compounding Ratio (%) | | | | | | | | Expansion | | |
|---|---|---|---|---|---|---|---|---|---|---|---|
| | In Base Material Resin | | | | | | | | Ratio | Impact | |
| | PP1 | PP2 | PE1 | PE2 | PE3 | PE4 | Weldability | Foamability | (Times) | Resistance | Stiffness |
| Example 1 | 70 | | 20 | 10 | | | Good | Good | 1.5 | Good | Good |
| Example 2 | 20 | | 70 | 10 | | | Good | Good | 2.5 | Good | Good |
| Example 3 | 60 | | 20 | 20 | | | Good | Good | 1.7 | Good | Good |
| Example 4 | 55 | | 30 | 15 | | | Good | Good | 1.8 | Good | Good |
| Example 5 | 65 | | 30 | 5 | | | Good | Good | 1.7 | Acceptable | Good |
| Example 6 | 50 | | 20 | 30 | | | Good | Good | 2.0 | Good | NA |
| Comparative | 70 | | 20 | | 10 | | Good | NA | 1.3 | NA | Good |
| Example 1 | | | | | | | | | | | |
| Comparative | 70 | | 20 | | | 10 | Good | NA | 1.2 | Good | Good |
| Example 2 | | | | | | | | | | | |
| Comparative | 10 | | 70 | 20 | | | NA | Good | 2.7 | Good | Good |
| Example 3 | | | | | | | | | | | |
| Comparative | | | 80 | 20 | | | NA | Good | 2.9 | Good | Good |
| Example 4 | | | | | | | | | | | |
| Comparative | 70 | | 30 | | | | Good | Good | 1.6 | NA | Good |
| Example 5 | | | | | | | | | | | |
| Comparative | 60 | 20 | | 20 | | | Good | Good | 1.8 | NA | Good |
| Example 6 | | | | | | | | | | | |

In the samples according to Examples 1 to 6, the compounding ratio by weight of the polypropylene-based resin with respect to the total amount of the base material resin was 20 to 70 wt %. The compounding ratio sufficiently ensured the above-described weldability and foamability in all of the samples, and also ensured impact resistance of the evaluation level of “Acceptable” or above.

In the samples of Example 1 to 4, the low-density polyethylene-based resin has a compounding ratio by weight of 10 to 20 wt % with respect to the total amount of the base material resin. The compounding ratio sufficiently ensured the above-described impact resistance and stiffness in addition to the weldability and foamability.

Particularly, in the sample of Example 2, the foaming polyethylene-based resin has a compounding ratio by weight of 50 wt % or more with respect to the total amount of the base material resin. This compounding ratio increased the expansion ratio by a factor of 2.5 as well as sufficiently ensuring the above-described weldability, foamability, impact resistance, and stiffness.

In the sample of Example 5, the above-described weldability and foamability were sufficiently ensured. However, because the compounding ratio by weight of PE2 was only 5 wt % of the base material resin, thus the impact resistance of only the evaluation level of “Acceptable” was ensured.

In the sample of Example 6, the compounding ratio of PE2 by weight of the base material resin was rather high at 30 wt %. In this way, in addition to the above-described weldability and foamability, impact resistance was also sufficiently ensured. However, stiffness was insufficient.

In the sample of Comparative Example 1, 10 wt % of PE3 was compounded as the low-density polyethylene-based resin, instead of PE2 having MT of 70 mN or more. However, PE3 did not mix well with the polypropylene-based resin. Thus, although weldability was ensured, foamability and impact resistance were insufficient.

In the sample of Comparative Example 2, 10 wt % of PE4 was compounded as the low-density polyethylene-based resin, instead of PE2 having MT of 70 mN or more. However, PE4 was unable to increase the expansion ratio, resulting in insufficient foamability, although weldability and impact resistance were ensured.

In the sample of Comparative Example 3, the compounding ratio of PP1 by weight of the base material resin was decreased to 10 wt %. Also, 70 wt % of PE1, i.e., the foaming polyethylene-based resin, was compounded. However, 10 wt % of polypropylene-based resin was too little, resulting in insufficient weldability as described above with respect to the molded article of the polypropylene-based resin.

In the sample of Comparative Example 4, the polypropylene-based resin was not compounded in the base material resin. Instead, the compounding ratio by weight of PE1 as the foaming polyethylene-based resin was rather increased, specifically to 80 wt % of the base material resin. However, because of the absence of the polypropylene-based resin, the sample did not weld to the molded article of polypropylene-based resin. Namely, weldability was insufficient.

In the sample of Comparative Example 5, the low-density polyethylene-based resin was not compounded. Instead, the base material resin comprised PP1 of polypropylene-based resin and PE1 of foaming polyethylene-based resin. Thus, the above-described weldability and foamability were sufficiently ensured. However, impact resistance was insufficient.

In the sample of Comparative Example 6, as the polypropylene-based resin, 20 wt % of PP2 having the MT×MFR value of 500 mN·g/10 min or more was compounded. Correspondingly, the compounding ratio of PE1 as the foaming polyethylene-based resin was set to 0 wt %. As a result, the above-described weldability, foamability, and stiffness were sufficiently ensured. However, impact resistance was insufficient. Further, because the relatively expensive foaming polypropylene-based resin was used rather than the inexpensive foaming polyethylene-based resin, the sample was not suitable from the viewpoint of cost reduction.

As described above, in the samples of Examples 1 to 6, at least weldability, foamability, and impact resistance with the evaluation level of “Acceptable” or above were ensured. On the other hand, in the samples of Comparative Examples 1 to 6, either weldability, foamability, or impact resistance was insufficient.

The present invention is not limited to lightweight climate control ducts for vehicles and may be used for, e.g., automobiles, aircraft, vehicles/ships, construction materials, and various electric device housings, or for structural members for sports or leisure purposes. The present invention may also be used for automobile structural members, such as interior panels including cargo floor boards, deck boards, rear parcel shelves, roof panels, and door trims; door inner panels; platforms; hard tops; sunroofs; hoods; bumpers; floor spacers; or tibia pads. In this way, the weight of the automobile can be decreased, enabling an increase in fuel economy.

The present application claims priority to Japanese Patent Application No. 2012-017033 filed on Jan. 30, 2012, the entire contents of which are herein incorporated by reference.

### DESCRIPTION OF REFERENCE SIGNS

10 Duct
21 Annular die
30 Clamping machine
31, 32 Split mold block
P Foamed parison

1. A method for manufacturing a foam-molded article, the method comprising foaming and molding a base material resin in which a first polyethylene-based resin, a second polyethylene-based resin, and a polypropylene-based resin are mixed, wherein
the first polyethylene-based resin has a long-chain branched structure with a density of 0.920 g/cm³ or more;
the second polyethylene-based resin is manufactured by a low pressure slurry method, has a long-chain branched structure with a density of 0.920 g/cm³ or less, and has a melt tensile force of 70 mN or more at 160° C.; and
the polypropylene-based resin has a compounding ratio of 20% or more by weight of the base material resin.

2. A method for manufacturing a foam-molded article according to claim 1, wherein
the second polyethylene-based resin has a compounding ratio of 10 to 20% by weight of the base material resin.

3. A method for manufacturing a foam-molded article according to claim 1, wherein
the first polyethylene-based resin has a compounding ratio of 50% or more by weight of the base material resin.

4. A foam-molded article obtained by foaming and molding a base material resin in which a first polyethylene-based resin, a second polyethylene-based resin, and a polypropylene-based resin are mixed, wherein
the first polyethylene-based resin has a long-chain branched structure with a density of 0.920 g/cm³ or more;
the second polyethylene-based resin is manufactured by a low pressure slurry method, has a long-chain branched structure with a density of 0.920 g/cm³ or less, and has a melt tensile force of 70 mN or more at 160° C.; and
the polypropylene-based resin has a compounding ratio of 20% or more by weight of the base material resin.

5. A method for manufacturing a foam-molded article according to claim 2, wherein
the first polyethylene-based resin has a compounding ratio of 50% or more by weight of the base material resin.

6. A foam-molded article according to claim 4, wherein
the second polyethylene-based resin has a compounding ratio of 10 to 20% by weight of the base material resin.

7. A foam-molded article according to claim 4, wherein
the first polyethylene-based resin has a compounding ratio of 50% or more by weight of the base material resin.

8. A foam-molded article according to claim 6, wherein
the first polyethylene-based resin has a compounding ratio of 50% or more by weight of the base material resin.
